(19) United States
(12) Patent Application Publication
(10) Pub. No.: US 2009/0126302 A1
(43) Pub. Date: May 21, 2009

(54) Material

(76) Inventor: Vaughan Thomas, Balnarring (AU)

Correspondence Address: Ballard Spahr Andrews & Ingersoll, LLP, SUITE 1000, 999 PEACHTREE STREET, ATLANTA, GA, 30309-3915, US

(21) Appl. No.: 11/666,710

(22) PCT Filed: Oct. 29, 2004
(86) PCT No.: PCT/AU2004/001498

§ 371 Date: Aug. 29, 2007

(30) Foreign Application Priority Data
Nov. 11, 2003 (AU) 2003926203
Jun. 2, 2004 (AU) 2004902963

(51) Int. Cl. E04B 1/88; B32B 3/10; B32B 3/26; E04C 3/02; E04B 1/92; E04B 1/74

(52) U.S. Cl. 52/407.3; 428/131; 428/304.4; 52/690; 52/741.3; 52/741.4

(57) ABSTRACT

An insulation material comprising a substrate (5) having a plurality of spaced attachment portions (7), each attachment portion (7) being formed so that in use structural members on either side of said substrate (5) can be adhered to one another where they overlie the attachment portions, and a plurality of spaced insulation portions (6) attached to said substrate (5) between said attachment portions (7).

### FIELD OF THE INVENTION

The present invention provides a material, methods of using the material and floor structures constructed using the material. In a first aspect, the invention material is an insulating material. In a second aspect, the invention material also provides an insulator.

### BACKGROUND TO THE INVENTION

In order to reduce construction costs there is a need for materials which can be installed efficiently.

Further, with increased concern about the sustainability of natural energy producing resources there has been an increased focus on the energy efficiency of buildings such as houses in order to reduce their energy requirements.

Whereas buildings built on concrete slabs have good thermal properties because the slab can absorb substantial amounts of heat, it is difficult to insulate floors where floors are built on a frame structure. Accordingly, there is also a need for an alternative technique for insulating such floors and appropriate materials for doing so.

### SUMMARY OF THE INVENTION

In a first aspect, the invention provides, an insulation material comprising:

a substrate having a plurality of spaced attachment portions, each attachment portion being formed so that in use structural members on either side of said substrate can be adhered to one another where they overlie the attachment portions; and

a plurality of spaced insulation portions attached to said substrate between said attachment portions.

Depending on the embodiment, said attachment portions may be formed by porous sections of said substrate or by perforations or apertures in said substrate which allow adhesive to pass from one side of the substrate to another.

The insulating portions may provide either or both thermal and acoustic insulation.

In one embodiment said substrate is formed from a heat reflecting material.

In one embodiment said substrate is a sheet of heat reflecting material.

In one embodiment said heat reflecting material is a sheet of aluminium foil.

In one embodiment said insulating portions are insulating batts.

The first aspect of the invention also provides a method of insulating a floor comprising a flooring material supported on a plurality of spaced joists, the method comprising:

providing a substrate having a plurality of spaced attachment portions;

overlaying said joists with said substrate with said attachment portions in register with said joists;

attaching said substrate to said joists such that said joists support said substrate and portions of said substrate hang below a top surface of said joists between the joists to thereby accommodate insulating material between the substrate and the intended level of the flooring between the joists;

providing insulating material between said joists; and

adhering said flooring material to said joists where said attachment portions overlie said joists.

In one embodiment, said method further comprises fastening said flooring material to said joists with one or more fasteners.

In one embodiment, said method comprises attaching said insulating material to said substrate.

In one embodiment providing said substrate comprises the step of perforating said material.

In one embodiment, said method comprises carrying out said perforating step and said step of attaching said insulating material to said substrate before said substrate is overlaid on said joists.

The first aspect of the invention also provides an insulated floor structure comprising:

a plurality of floor joists;

a substrate comprising a plurality of spaced attachment portions, said substrate overlaying said joists with said attachment portions in register with said joists, said substrate being attached to said joists such that said joists support said substrate and portions of said substrate hang below the top surfaces of said joists between said joists;

flooring material supported by the top surfaces of said joists and adhered to said joists where said attachment regions overlie said joists; and

insulating material supported by the substrate in the gaps defined between the portions of said substrate which hang below the top surfaces of said joists and the bottom surface of said flooring material.

Depending on the embodiment, said attachment portions may be formed by porous sections of said substrate or by perforations in said substrate which allow adhesive to pass from one side of the substrate to another. Depending on the embodiment, the size of said perforations may vary from small holes to larger apertures.

In one embodiment said insulating material is attached to said substrate.

In one embodiment said substrate is formed from a heat reflecting material.

In one embodiment said substrate is a sheet of heat reflecting material.

In one embodiment said heat reflecting material is a sheet of aluminium foil.

In one embodiment said insulating material is a plurality of insulating batts.

In a second aspect, the invention provides, a fire protection material comprising:

a substrate formed of a fire rated material, the substrate having a plurality of spaced attachment portions, each attachment portion being formed so that in use structural members on either side of said substrate can be adhered to one another where they overlie the attachment portions with the fire rated material extending between the structural members to provide fire protection.

Depending on the embodiment, said attachment portions may be formed by porous sections of said substrate or by perforations or apertures in said substrate which allow adhesive to pass from one side of the substrate to another.

The fire protection material may further comprise a plurality of spaced apart insulation portions attached to the substrate between the attachment portions.

The insulating portions may provide thermal and/or acoustic insulation.

The second aspect of the invention also provides a method of fire protecting a floor comprising a flooring material supported on a plurality of spaced joists, the method comprising:

providing a substrate formed of a fire rated material having a plurality of spaced attachment portions;

locating said substrate with said attachment portions in register with said joists;

attaching said substrate to said joists such that said joists support said substrate and portions of said substrate extend between the joists to thereby provide fire protection; and

adhering a flooring material or a ceiling material to said joists where said attachment portions overlie said joists.

Where the floor is the lowest floor of a structure, the substrate is typically overlaid on the joists and a flooring material is adhered to the joists.

Where the floor is between levels of a structure, the substrate may be either located between the flooring material and the joists or between the joists and the ceiling material or an additional layer of substrate may be provided and substrates may be provided both between the flooring material and the joists and between the ceiling material and joists.

The method may further comprise insulating the floor by providing thermal and/or acoustic insulating material carried by the substrate between the joists.

In one embodiment, said method further comprises fastening said flooring and/or ceiling material to said joists with one or more fasteners.

The second aspect of the invention also provides a floor structure comprising:

a plurality of floor joists;

a substrate formed of a fire rated material comprising a plurality of spaced attachment portions, said substrate located with said attachment portions in register with said joists; and

flooring and/or ceiling material carried by the joists and adhered to said joists where said attachment regions overlie said joists.

The floor structure may further comprise an acoustic and/or thermal insulating material supported by the substrate in the gaps defined between said joists.

The floor structure may comprises an additional substrate with one substructure located between the joists and the flooring material and the other substrate located between the joists and the ceiling material.

The invention also provides an insulation material for insulating a floor structure having a plurality of joists for supporting a flooring material, the insulation material comprising:

a web; and

a plurality of spaced apart insulation members attached to said web and separated from each other by portions of said web, the insulation members being spaced so that the portions of the web separating neighbouring insulation members are sufficient to accommodate a joist with the insulation members between the joists and below the flooring material.

The invention also provides a floor structure comprising:

an plurality of floor joists;

an insulation material comprising a web of material and a plurality of spaced apart insulation members attached to said web and located with the insulation members between the joists; and

a flooring material supported by the top surfaces of the joists.

### BRIEF DESCRIPTION OF THE DRAWINGS

A preferred embodiment of the invention will now be described in relation to the following drawings in which:

FIG. 1 is a cross-section of a floor structure built in accordance with the first preferred embodiment of the invention;

FIG. 2 is a partial cut-away plan view of the insulating material of the present invention installed between a pair of joists;

FIG. 3 is a cross-structure of a floor structure which shows the use of a fire rated material; and

FIG. 4 shows how two layers of fire rated material may be installed.

### DESCRIPTION OF THE PREFERRED EMBODIMENT

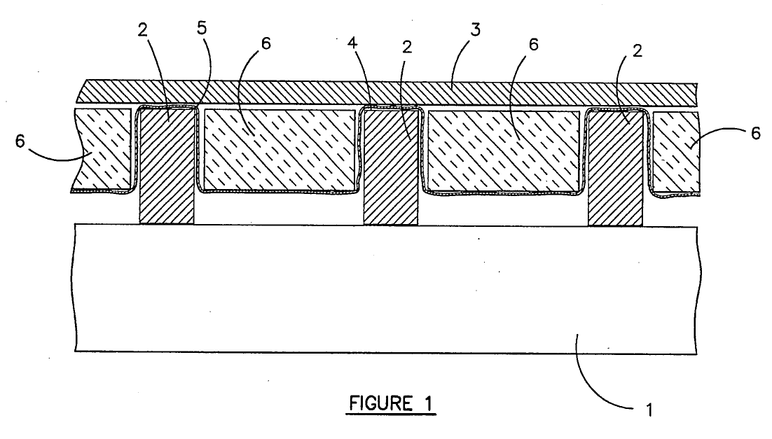

FIG. 1 illustrates a floor structure which formed using a method of insulating a floor and a insulation material of the first preferred embodiment.

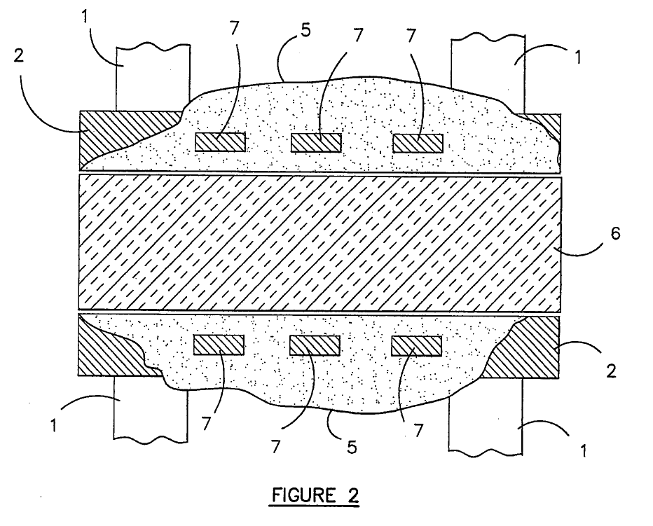

The floor structure comprises a plurality of bearers which will usually be supported on stumps (not shown) inserted into the ground. The bearer 1 illustrated in FIG. 1 is one of a plurality of bearers which all run in the same direction (see FIG. 2). Supported on these bearers 1 are a plurality of joists 2 which run perpendicularly to the bearers 1.

In order to insulate the floor structure, an insulation material comprising a substrate in the form of a sheet of aluminium foil 5 and a plurality of insulation portions in the form of insulating batts 6 formed of fibre glass are overlaid on the joists such that they are supported by the joists 2 with the insulating batts 6 below the intended level of the flooring material 3. The aluminium foil is fastened to the joists, typically by staples using a staple gun. The flooring material may be wooden floor boards, composite board, particle board or the like.

As shown in FIG. 2, the insulation material has a plurality of apertures 7 through the material which are spaced apart in order to correspond to the spacing of the joists 2. These apertures 7 provide attachment portions for allowing the flooring material 3 to be attached to the joists. That is the attachment portions permit attachment of the flooring and joists rather than acting to actively attach the substrate to the joists (the substrate can be separately attached to the joists by fasteners, if desired).

These apertures allow flooring 3 to be adhered to joists 2, thus preventing the floor from squeaking. Furthermore, the flooring 3 is also fastened to the joists 2 by fasteners such as nails.

It will thus be seen by referring to FIG. 1 that the substrate 5 hangs below the top surface 4 in order to accommodate the insulating batts 6. Thus, persons skilled in the art will appreciate that the additional length of aluminium foil 5 between the attachment portions which overlie the joists and one side of the batt 6 corresponds substantially to the height of the insulating batts. Typically, the joist spacing is 450 mm in which case the length of aluminium foil from attachment portion to attachment portion is about 620 mm. Similarly, if the joist spacing is 600 mm the length of aluminium foil is about 770 mm.

The insulation material of the preferred embodiment will usually be supplied as a roll of material. As the spacing of joists is standard, one end of the roll can be aligned and then, the material can be deployed rapidly by rolling it out.

Persons skilled in the art will appreciate that there are a large number of alternative embodiments which fall within the scope of the invention.

For example, while the invention has been described in relation to a wooden structure for supporting flooring material, the invention is equally applicable to situations where the frame is metal.

Similarly, while the spaced attachment portions in the preferred embodiment are provided by a number of apertures, the attachment portions may be provided by many other type of perforations provided these allow adhesive to pass from one side of the material to another in order to allow the flooring to be adhered to the joists to prevent squeaking. Indeed, the substrate may be formed from a porous material or have porous portions where it is designed to be attached to the joists.

Further, while it is preferred that the substrate is a sheet of heat reflecting aluminium foil, it will appreciated that other substrates may be used while obtaining some or all of the benefits of the present invention. For example, other heat reflecting materials will clearly be suitable. Further, where the substrate is merely required to support the insulating material it need not be formed of a heat reflecting material. It could be for example, formed of plastic. In one particularly preferred embodiment, the substrate is formed of a fire rated material to thereby provide fire protection in addition to insulation.

The substrate may also be a web, for example a lattice-like web of strips of material and function to support the insulating portions. Further, while it is preferred that the insulating portions are supported against gravity by the substrate or web, the insulating material can be supported by its attachment to the substrate or web and hang below the substrate or web in use. This is particularly suitable where the insulation material is to be installed between floors, as if the material becomes detached it will still be supported, for example by the ceiling.

In the preferred embodiment, the insulating portions are provided by fibre glass batts adhered to the aluminium foil. Persons skilled in the art will appreciate that other insulating materials may also be used—e.g. polyester batts or rockwool. The insulating material may alternatively or additionally be chosen to provide acoustic insulation.

Further, in embodiments where the invention is provided in the form of a insulation material, the insulating material must be attached to the substrate in order to allow for ready installation. However, where the invention is embodied as a floor structure or as a method, the insulating material could be provided separately and installed separately to the substrate. Although, it is preferred that it is provided with insulating material attached to the substrate.

Further, while the example of fasteners used to attach the substrate to the joists and the flooring to the joists are given above a person skilled in the art will appreciate the number of different fasteners can be used. For example, if a metal floor substrate is used, fasteners in the form of screws would be more appropriate than nails. Further, it may be possible to attach the substrate to the joist using an adhesive rather than staples depending on the embodiment.

In a further embodiment of the method of the invention, the substrate could be perforated after it has been installed in order to match to the joists spacing.

Persons skilled in the art will also appreciate that joists and bearers could run in different directions in different areas of the floor structure.

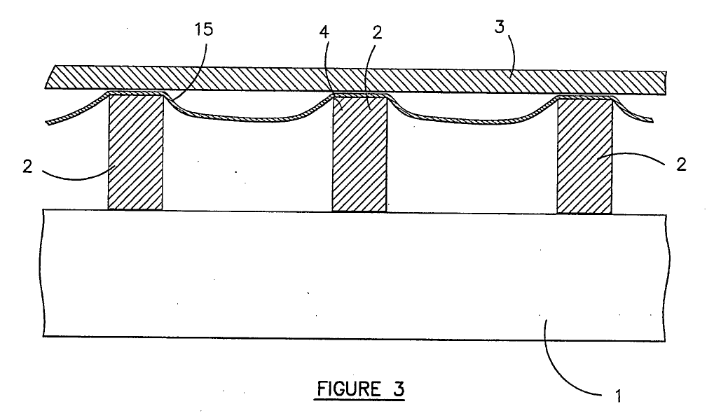

Referring to FIG. 3 there is shown a second embodiment which relates to the second aspect of the invention.

As discussed above, the substrate can be a fire rated material in order to provide fire protection to the structure. FIG. 3 illustrates that in accordance with the second aspect of the invention a substrate 15 formed of a fire rated material may be conveniently installed in the building with the substrate otherwise constructed in accordance with the substrate of the first embodiment—that is by providing attachment portions where an adhesive can pass through the substrate 15 in order to allow the flooring 3 to be attached to the joists 2. The material can then be rapidly deployed in the construction of a structure by rolling it out over the joist with the attachment portions in register with the joists. The flooring material can then be deployed very quickly during construction of the structure.

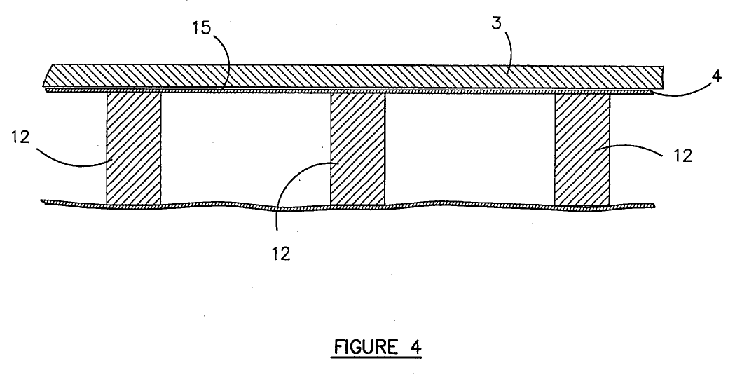

FIG. 4 shows an alternative embodiment where fire rated substrate 15 is located between a floor 3 and a ceiling material (not shown) where the floor 3 is between two different levels of a structure. The substrate 15 formed of fire rated material is attached to both the top and bottom of the deep floor joists of the floor structure to provide fire protection between the two levels of the building. There may also be provided a thermal or acoustic insulating material carried by one or both of the substrates.

A person skilled in the art will appreciate that numerous other variations fall within the scope of the invention described herein. For example, where there is a danger of moisture build up on the substrate, drainage holes may be provided in the substrate to allow moisture to pass therethrough.

The claims defining the invention are as follows:

1. An insulation material comprising:
a substrate having a plurality of spaced attachment portions, each attachment portion being formed so that in use structural members on either side of said substrate can be adhered to one another where they overlie the attachment portions; and
a plurality of spaced insulation portions attached to said substrate between said attachment portions.

2. An insulation material as claimed in claim 1, wherein said attachment portions are porous sections of said substrate.

3. An insulation material as claimed in claim 1, wherein said attachment portions are perforated sections of said substrate.

4. An insulation material as claimed in claim 1, wherein said perforations are apertures therethrough.

5. An insulation material as claimed in claim 1, wherein the insulation portions provides either or both of thermal and acoustic insulation.

6. An insulating material as claimed in claim 1, wherein said substrate is formed from a heat reflecting material.

7. An insulating material as claimed in claim 1, wherein said substrate is a sheet of heat reflecting material.

8. An insulating material as claimed in claim 6, wherein said heat reflecting material is a sheet of an aluminium based foil.

9. An insulating material as claimed in claim 1, wherein said insulating portions are insulating batts.

10. A method of insulating a floor comprising a flooring material supported on a plurality of spaced joists, the method comprising:
providing a substrate having a plurality of spaced attachment portions;
overlaying said joists with said substrate with said attachment portions in register with said joists;
attaching said substrate to said joists such that said joists support said substrate and portions of said substrate hang below a top surface of said joists between the joists to thereby accommodate insulating material between the substrate and the intended level of the flooring between the joists;
providing insulating material between said joists; and
adhering said flooring material to said joists where said attachment portions overlie said joists.

11. A method as claimed in claim 10, comprising fastening said flooring material to said joists with one or more fasteners.

12. A method as claimed in claim 10, comprising attaching said insulating material to said substrate.

13. A method as claimed in claim 10, further comprising forming said attachment portions by perforating said substrate.

14. A method as claimed in claim 13, comprising carrying out said perforating step before said substrate is overlaid on said joists.

15. A method as claimed in claim 14, wherein said substrate is provided with said perforations.

16. A method as claimed in claim 14, comprising carrying out said step of attaching said insulating material before said substrate is overlaid on said joist.

17. An insulated floor structure comprising:
a plurality of floor joists;
a substrate comprising a plurality of spaced attachment portions, said substrate overlaying said joists with said attachment portions in register with said joists, said substrate being attached to said joists such that said joists support said substrate and portions of said substrate hang below the top surfaces of said joists between said joists;
flooring material supported by the top surfaces of said joists and adhered to said joists where said attachment regions overlie said joists; and
insulating material supported by the substrate in the gaps defined between the portions of said substrate which hang below the top surfaces of said joists and the bottom surface of said flooring material.

18. An insulated floor structure as claimed in claim 17, wherein said attachment portions may be formed by porous sections of said substrate.

19. An insulated floor structure as claimed in claim 17, wherein said attachment portions are formed by perforations in said substrate.

20. A insulated floor structure as claimed in claim 17, wherein said insulating material is attached to said substrate.

21. An insulated floor structure as claimed in claim 17, wherein said substrate is a sheet of heat reflecting material.

22. An insulated floor structure as claimed in claim 21, wherein said heat reflecting material is a sheet of an aluminium based foil.

23. An insulated floor structure as claimed in claim 22, wherein said insulating material comprises a plurality of insulating batts.

24. A fire protection material comprising:
a substrate formed of a fire rated material, the substrate having a plurality of spaced attachment portions, each attachment portion being formed so that in use structural members on either side of said substrate can be adhered to one another where they overlie the attachment portions with the fire rated material extending between the structural members to provide fire protection.

25. A fire protection material as claimed in claim 24, wherein said attachment portions may be formed by porous sections of said substrate.

26. A fire protection material as claimed in claim 24, wherein said attachment portions are formed in said substrate which allow adhesive to pass from one side of the substrate to another.

27. A fire protection material as claimed in claim 24, further comprising a plurality of spaced apart insulation portions attached to the substrate between the attachment portions.

28. A fire protection material as claimed in claim 24, wherein the insulating portions may provide thermal and/or acoustic insulation.

29. A method of fire protecting a floor comprising a flooring material supported on a plurality of spaced joists, the method comprising:
providing a substrate formed of a fire rated material having a plurality of spaced attachment portions;
locating said substrate with said attachment portions in register with said joists;
attaching said substrate to said joists such that said joists support said substrate and portions of said substrate extend between the joists to thereby provide fire protection; and
adhering a flooring material or a ceiling material to said joists where said attachment portions overlie said joists.

30. A method of fire protecting a floor as claimed in claim 29, wherein the floor is the lowest floor of a structure, the substrate is typically overlaid on the joists and the flooring material is adhered to the joists.

31. A method of fire protecting a floor as claimed in claim 29, wherein the floor is between levels of a structure and wherein the substrate may be either located between the flooring material and the joists or between the joists and the ceiling material.

32. A method of fire protecting a floor as claimed in claim 31, wherein an additional layer of substrate is provided and substrates are provided both between the flooring material and the joists and between the ceiling material and joists.

33. A method as claimed in claim 29, further comprising insulating the floor by providing thermal and/or acoustic insulating material carried by the substrate between the joists.

34. A method as claimed in claim 29, further comprising fastening said flooring and/or ceiling material to said joists with one or more fasteners.

35. A floor structure comprising:
a plurality of floor joists;
a substrate formed of a fire rated material comprising a plurality of spaced attachment portions, said substrate located with said attachment portions in register with said joists;
flooring and/or ceiling material carried by the joists and adhered to said joists where said attachment regions overlie said joists.

36. A floor structure as claimed in claim 35, comprising an acoustic and/or thermal insulating material supported by the substrate in the gaps defined between said joists.

37. A floor structure as claimed in claim 35, comprising an additional substrate with one substrate located between the joists and the flooring material and the other substrate located between the joists and the ceiling material.

38. An insulation material for insulating a floor structure having a plurality of joists for supporting a flooring material, the insulation material comprising:
a web; and
a plurality of spaced apart insulation members attached to said web and separated from each other by portions of said web, the insulation members being spaced so that the portions of the web separating neighbouring insulation members are sufficient to accommodate a joist with the insulation members between the joists and below the flooring material.

39. An insulation material as claimed in claim 38, wherein the insulation members provide thermal and/or acoustic insulation.

40. An insulation material as claimed in claim 38, wherein at least part of the portions of the web between the insulation members allows the flooring material to be glued to the joists with the web sandwiched therebetween.

41. An insulation material as claiming in claim 38, wherein the insulating members are insulating batts.

42. A floor structure comprising:
an plurality of floor joists;
an insulation material comprising a web of material and a plurality of spaced apart insulation members attached to said web and located with the insulation members between the joists; and
a flooring material supported by the top surfaces of the joists.
